(19) United States
(12) Patent Application Publication
(10) Pub. No.: US 2017/0212381 A1
(43) Pub. Date: Jul. 27, 2017

(54) Liquid Crystal Display Without Bezel

(71) Applicant: Motorola Mobility LLC, Chicago, IL (US)

(72) Inventors: Allen B. McKittrick, Grayslake, IL (US); Andrew Herrmann, Chicago, IL (US); Jonathan C. Richard, Chicago, IL (US); Kamyin Cheng, Chicago, IL (US); Adam R. Cole, Gurnee, IL (US)

(21) Appl. No.: 15/007,702

(22) Filed: Jan. 27, 2016

(51) Int. Cl. G02F 1/1333; G02F 1/1335

(52) U.S. Cl. CPC G02F 1/133308; G02F 1/133553; G02F 1/133528; G02F 2001/133314; G02F 2001/133325

(57) ABSTRACT

A device includes a liquid crystal display panel, a compression pad, and a bottom chassis. The bottom chassis supports the liquid crystal display panel. The compression pad has a first surface facing the liquid crystal display panel and a second surface opposite the first surface. The second surface faces away from the liquid crystal display panel. The compression pad substantially fills a volume between the liquid crystal display panel and the bottom chassis. Also, a method of assembling a device includes providing a liquid crystal display panel having a display module reflector, aligning a compression pad assembly with the liquid crystal display panel, and removing a compression pad liner from the compression pad. The compression pad assembly includes the compression pad and the compression pad liner.

### FIELD

The disclosure relates generally to the liquid crystal displays (LCDs) for mobile devices, and more specifically to devices and methods for LCDs that do not include a bezel.

### BACKGROUND

In the world of smartphones, the bezel functions acts as a shield and protects the back of the phone display. In the early days, cellphones were almost entirely bezel—screens were tiny, and because they lacked touchscreen interaction, that was fine. Once we began to poke and swipe at our screens, though, they got bigger—and the frame that was structurally necessary to keep them stable began to get smaller and smaller.

It follows, by some logic, that the next evolutionary step would be to get rid of the bezel altogether. However, removing a bezel is not without difficulties. As provided above, the bezel offers structural support to smartphones. The bezel is often form fitted to the display screen of a phone, wrapping around the edge and extending beneath the display screen or main lens of the phone. Without bezel protection, the display is more susceptible to any point load or line load to the backside of the display screen, causing visual defects. These permanent and dynamic visual defects are often referred to as dynamic bloom, white/dark/blue spots and edge glow, but may be referred to collectively as “pressure marks.”

### SUMMARY

Accordingly, there are provided herein devices and methods that allow for bloom or pressure mark protection for a thin liquid crystal display (LCD) product without a formed metal bezel.

In a first aspect, a device is disclosed. The device includes: a liquid crystal display panel; a compression pad having a first surface facing the liquid crystal display panel and a second surface opposite the first surface, the second surface facing away from the liquid crystal display panel, the compression pad substantially filling a volume between the liquid crystal display panel and a bottom chassis; and a bottom chassis that supports the liquid crystal display panel.

In a second aspect, a method of assembling a device is disclosed. The method includes: providing a liquid crystal display panel having a display module reflector; aligning a compression pad assembly with the liquid crystal display panel, the compression pad assembly including a compression pad and a compression pad liner; and removing the compression pad liner from the compression pad.

### BRIEF DESCRIPTION OF THE DRAWINGS

The details of the present disclosure, both as to its structure and operation, may be understood in part by study of the accompanying drawings, in which like reference numerals refer to like parts. The drawings are not necessarily to scale, emphasis instead being placed upon illustrating the principles of the disclosure.

FIG. 1 is a perspective view of an example mobile device with a display bezel.

FIG. 2 is a perspective view of an example mobile device without a display bezel.

FIG. 3 is a perspective view an example mobile device with a compression pad in accordance with an embodiment.

FIG. 4 is an example graph showing the compression load (N/cm²) versus the compression ratio (%) for a compression pad in accordance with an embodiment.

FIG. 5A is a perspective exploded view of an example mobile device with a compression pad in accordance with an embodiment.

FIG. 5B is a front top view of an example mobile device in a first assembly position in accordance with an embodiment.

FIG. 5C is a front top view of an example mobile device in a second assembly position in accordance with an embodiment.

FIG. 5D is a close up of a top portion of FIG. 5C.

FIG. 5E is a front top view of an example mobile device in a third assembly position in accordance with an embodiment.

FIG. 6A is a perspective exploded view of an example mobile device in a first assembly position in accordance with an embodiment.

FIG. 6B is a top view showing a general front side and backside of an LCD module for the example mobile device of FIG. 6A.

FIG. 6C is a perspective exploded view of an example mobile device in a second assembly position in accordance with an embodiment.

FIG. 6D is a perspective exploded view of an example mobile device in a third assembly position in accordance with an embodiment.

FIG. 7 is a perspective view of an example mobile device showing gaps in the mobile device.

### DETAILED DESCRIPTION

The present disclosure describes methods and systems for that allow for bloom or pressure mark protection for a thin LCD product without a formed metal bezel. In some embodiments, the LCD product includes a low compression force pad proximate to the back of a display module reflector, between the display and chassis, to distribute point loads, thereby reducing the occurrence of pressure marks.

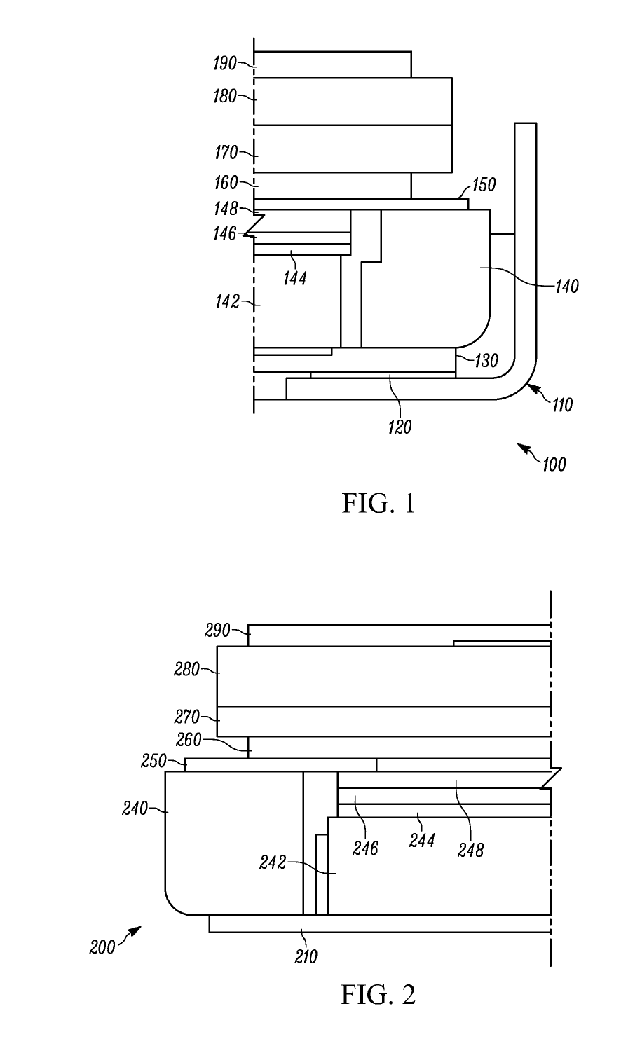

FIG. 1 is a perspective view of an example mobile device with a display bezel. As shown, mobile device is not an entire mobile device, but rather a liquid crystal display (LCD) module 100. LCD module 100 includes a metal bezel 110, a reflector 130 and a light guide frame (LGF) 140. Metal bezel 110 is connected to reflector 130 via adhesive 120. LGF 140 is configured to hold LCD module 100 together by means of mechanical features and adhesives. Adhesive 120 may be made of any suitable adhesive material, including for example, glues and/or epoxies. Reflector 130 may be a multilayered plastic film that functions as a mirror.

In some embodiments, the metal bezel 110 has a thickness of approximately 0.150 mm. Reflector 130 may have a thickness of around 0.082 mm. Adhesive 120 has a thickness of approximately 0.03 mm to approximately 0.08 mm.

As shown, metal bezel 110 does not effectively solve bloom issues or pressure marks associated with LCD module 100. This is because point or edge loads translate through the thin metal bezel 110 and into the LCD module 100 with minimal load distribution. When the load is minimally distributed, the applied pressure is higher through the LCD module 100 (e.g., Pressure=Force/Area). The higher pressure results in more deflection through the layers of the LCD module 100 and reduces the gap between the front and back glass prisms 146, 148 containing the liquid crystal. The effect is bloom.

LCD module 100 also includes a light guide 142, a diffuser film 144, a lower prism 146, and an upper prism 148. In some embodiments, the light guide 142 is constructed from plastic and distributes light from light emitting diodes (LEDs) throughout LCD module 100. In some embodiments, diffuser film 144 is constructed from plastic and spreads light throughout the display. In some embodiments, the lower prism 146 and upper prism 148 are constructed from plastic and are brightness enhancement films that focus light. One prism 146 or 148 focuses light in the horizontal direction and the other prism 146 or 148 focuses light in the vertical direction. Also shown is a rim adhesive 150 that allows the prisms 146, 148 to be secured to LFG 140.

In some embodiments, light guide 142 has a thickness of approximately 0.45 to 0.56 mm. Diffuser film 144 may have a thickness of around 0.05 mm. Lower prism 146 may have a thickness of approximately 0.065 mm and upper prism 148 may have a thickness of approximately 0.095 mm.

LCD module 100 also includes a back polarizer 160, a lower prism 170, an upper prism 180, and a front polarizer 190. In some embodiments, the back polarizer 160 is constructed from plastic and allows light to pass at a specific polarization. In some embodiments, lower prism 170 is constructed from glass and holds a thin film transistor (TFT), which carries electrical current to the liquid crystal and forces it to either block or omit light. In some embodiments, the liquid crystal (not shown) is located between lower prism 170 and upper prism 180. In some embodiments, upper prism 180 is constructed from glass and includes a color filter for red, green, and blue (RGB). Each RGB filter is associated with a transistor that defines the color that will be visible (e.g., a pixel). In some embodiments, front polarizer 190 is constructed from plastic and allows light to pass at a specific polarization.

FIG. 2 is a perspective view of an example mobile device without a display bezel. As shown, mobile device is not an entire mobile device, but rather an LCD module 200. LCD module 200 includes a reflector 210 and a light guide frame (LGF) 240. LGF 240 is configured to hold LCD module 200 together by means of mechanical features and adhesives. Reflector 210 may be a multilayered plastic film that functions as a mirror.

LCD module 200 also includes a light guide 242, a diffuser film 244, a lower prism 246, and an upper prism 248. In some embodiments, the light guide 242 is constructed from plastic and distributes light from light emitting diodes (LEDs) throughout LCD module 200. In some embodiments, diffuser film 244 is constructed from plastic and spreads light throughout the display. In some embodiments, the lower prism 246 and upper prism 248 are constructed from plastic and are brightness enhancement films that focus light. One prism 246 or 248 focuses light in the horizontal direction and the other prism 246 or 248 focuses light in the vertical direction. Also shown is a rim adhesive 250 that allows the prisms 246, 248 to be secured to LFG 240.

LCD module 200 also includes a back polarizer 260, a lower prism 270, an upper prism 280, and a front polarizer 290. In some embodiments, the back polarizer 260 is constructed from plastic and allows light to pass at a specific polarization. In some embodiments, lower prism 270 is constructed from glass and holds a thin film transistor (TFT), which carries electrical current to the liquid crystal and forces it to either block or omit light. In some embodiments, the liquid crystal (not shown) is located between lower prism 270 and upper prism 280. In some embodiments, upper prism 280 is constructed from glass and includes a color filter for red, green, and blue (RGB). Each RGB filter is associated with a transistor that defines the color that will be visible (e.g., a pixel). In some embodiments, front polarizer 290 is constructed from plastic and allows light to pass at a specific polarization.

A main difference between FIG. 1 and FIG. 2 is that FIG. 1 includes a bezel 110 and adhesive 120 to secure it to the LCD module 110. Generally, the sizes (e.g., thicknesses) of like components are similar. However, the overall thickness of mobile device 100 is greater than mobile device 200 due to including the bezel 110.

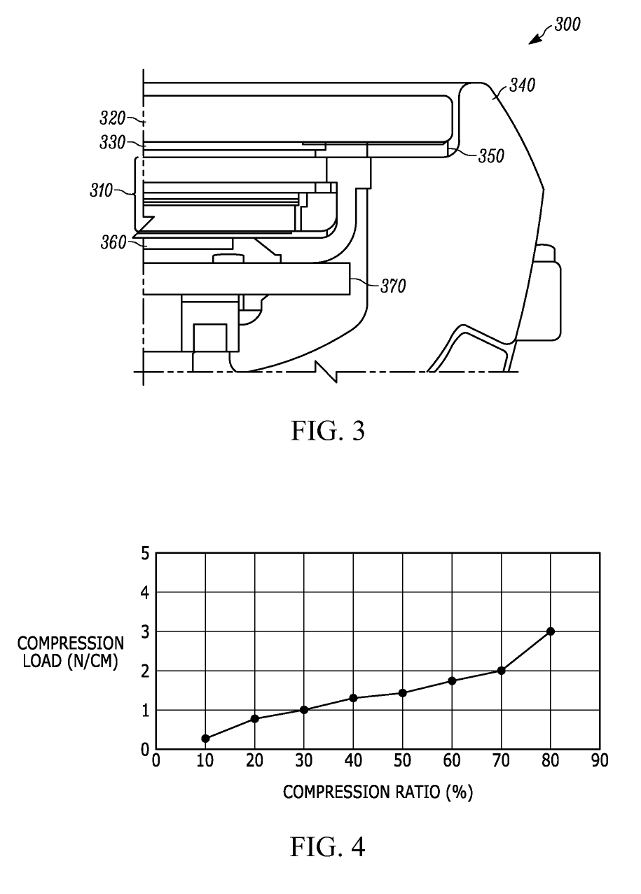

FIG. 3 is a perspective view an example mobile device 300 with a compression pad in accordance with an embodiment. Unlike in FIG. 1 and FIG. 2, FIG. 3 shows a mobile device 300 including an LCD module 310 and additional components, making a more complete phone. It should be appreciated that for purposes of discussion, LCD module 310 may include similar components to LCD module 200.

Mobile device 300 also includes a main lens 320, which may be constructed of a transparent material such as glass. Main lens 320 may be secured to the LCD module 310 via an optically clear adhesive (OCA) 330. OCA 330 may be approximately 0.15 thick and made from any suitable adhesive.

Also shown are front housing 340, which is secured to main lens 320 via main lens adhesive 350. In some embodiments, front housing is constructed from aluminum die cast and over-molded PC plastic. Main lens adhesive 350 may be any suitable adhesive and is approximately 0.25 mm thick. Proximate to and beneath LCD module 310 is compression pad 360. As shown, compression pad 360 is in contact with a reflector or reflector film (not shown) of LCD module 360. Beneath compression pad 360 is a chassis 370. As shown, chassis 370 is generally a bottom structure of mobile device 300, however in some embodiments, it may be a printed circuit board (not shown) of other internal phone component that is located beneath the LCD module 310.

In some embodiments, compression pad 360 substantially fills a volume between the LCD module 310 and chassis 370. In some embodiments, compression pad 360 effectively minimizes or removes any gaps in mobile device 300 between LCD module 310 and chassis 370. Thus, compression pad 360 is at least partially compressed between LCD module 310 and chassis 370.

The compression force on the compression pad 360 is important, because if compression force is too high, it may overstress the lens bond between main lens 320 and LCD module 330. Too much force from the compression pad 360 may force the main lens 320 to detach from the phone. If compression force is too low, the compression pad 360 may not be effective to distribute point and/or line loads.

Material properties for suitable compression pads 360 are provided in Tables 1 and 2. In some embodiments, compression pad 360 has a thickness of approximately 0.3 mm to 0.4 mm. However, it is appreciated that the thickness of the compression pad 360 may vary, depending on the size of a gap between the LCD module 310 and chassis 370. Additionally, the width and length of compression pad 360 will vary according to the display size.

TABLE 1
Compression Pad Dimensions

| Thickness (mm) | Width (mm) | Length (mm) |
|---|---|---|
| 0.3-0.4 | 36 | 117 |

TABLE 2
Compression Pad General Properties

| Property | Unit | Values | Test Method |
|---|---|---|---|
| Density | g/cm³ | 0.045 | JIS K 6767 |
| 50% Compression Load | N/cm² | 1.4 | JIS K 6767 |

In some embodiments, compression pad 360 is constructed from a compressible or pliable material such as polypropylene, polyethylene terephthalate, silicone, thermoplastic urethane, or other suitable porous materials. In some embodiments, compression pad 360 has a density of approximately 0.02 to 2.3 g/cm³. The range of densities may be dependent on the material of compression pad 360. For example, a compression pad 360 having a density of 0.02 g/cm³ to 1 g/cm³ is a highly porous compressible pad 360 and a compression pad 360 having a density of 1 g/cm³ to 2.3 g/cm³ is a nonporous compressible pad 360 such as silicone rubber. In some embodiments, compression pad 360 has a 50% compression load of approximately 0.5 to 5 N/cm².

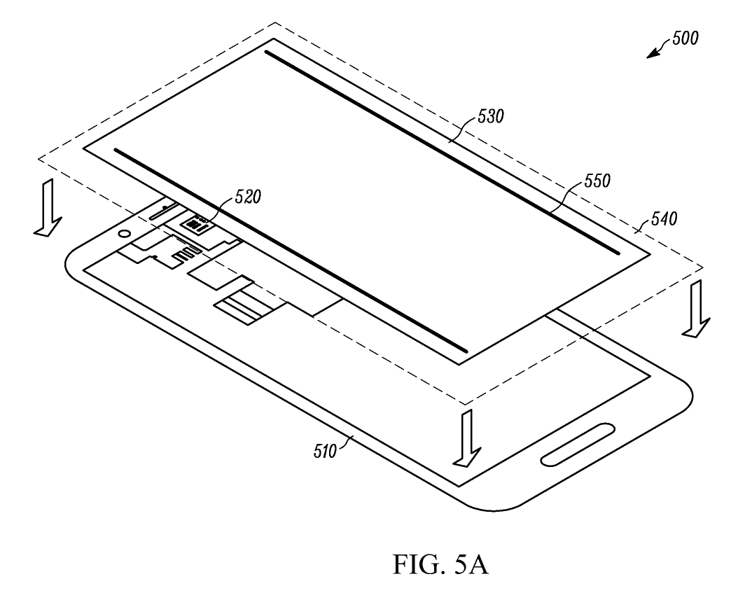

FIG. 4 is an example graph showing the compression load (N/cm²) versus the compression ratio (%) for a suitable compression pad material.

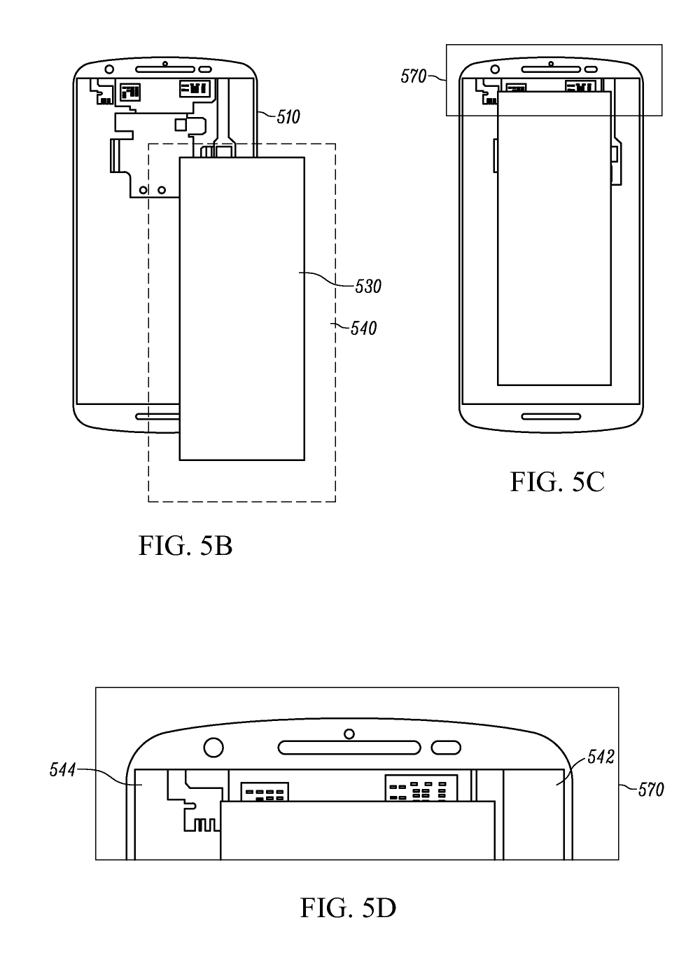

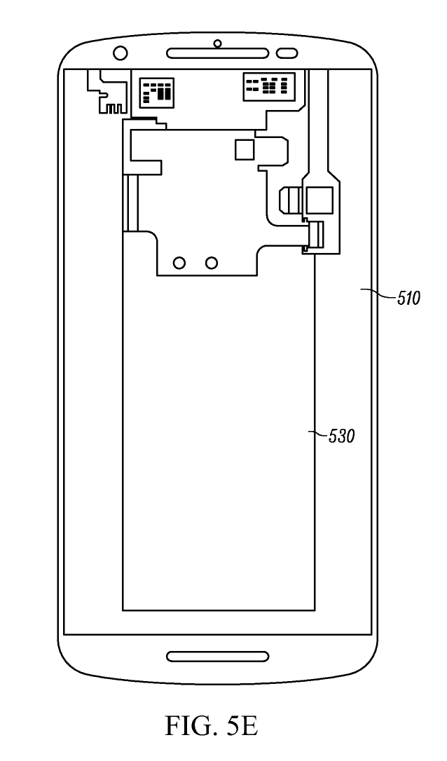

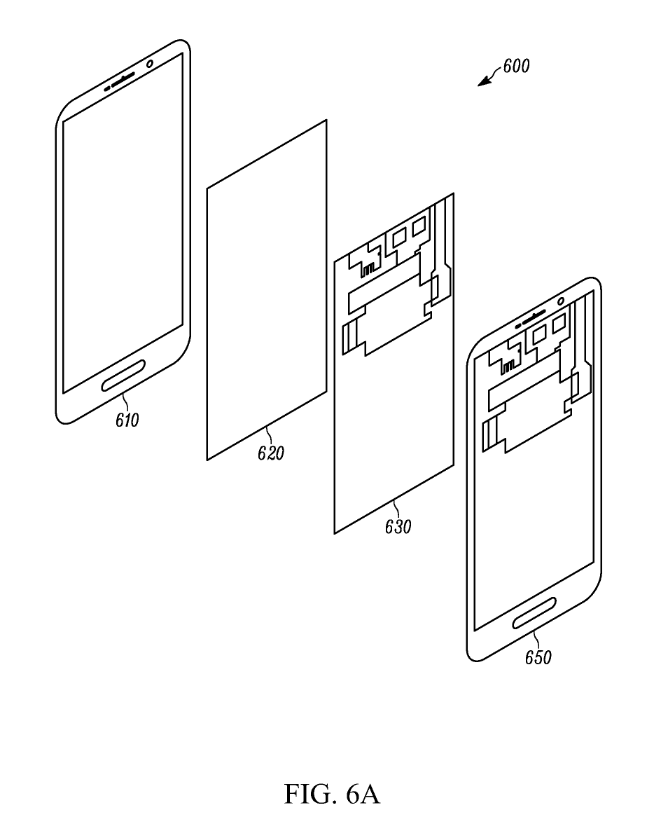

FIG. 5A is a perspective exploded view of an example mobile device with a compression pad in accordance with an embodiment. In FIG. 5A, mobile device 500 includes a main lens and a display assembly 510 or LCD module. Also included in display assembly 510 is a display flex 520, which includes a processor chip and supporting circuitry. The display flex 520 connects to the phone's main printed circuit board (PCB).

Also shown in FIG. 5A are a compression pad 530 and a compression pad liner 540. Compression pad 530 includes one or more adhesive strips 550 that run the length of the compression pad 530. The adhesive strips 550 are located on the underside of compression pad 530, proximate to display assembly 510, and are used to secure the compression pad 530 to the display assembly 510.

FIG. 5B is a front top view of an example mobile device in a first assembly position in accordance with an embodiment. In FIG. 5B, mobile device 500 is shown with compression pad liner 540 and compression pad 530 unattached to display assembly 510.

FIG. 5C is a front top view of an example mobile device in a second assembly position in accordance with an embodiment. In FIG. 5C, mobile device 500 is shown with compression pad liner 540 and compression pad 530 placed on top of display assembly 510. A top portion 570 of mobile device 500 is also shown, where the compression pad liner 540 is aligned to a top edge of the display assembly 510 in order to properly position the compression pad 530 on the display assembly 510.

FIG. 5D is a close up of a top portion of FIG. 5C. In top portion 570, two corners 542, 544 of compression pad liner 540 are shown which align with two corners of the display assembly 510. In some embodiments, the compression pad liner 540 aligns with the display reflector of display assembly 510.

FIG. 5E is a front top view of an example mobile device in a third assembly position in accordance with an embodiment. In FIG. 5E, the compression pad liner 540 has been removed after placing the compression pad 530 in its correct position. As provided above, the compression pad 530 is secured to display assembly 510 with adhesive strips 550.

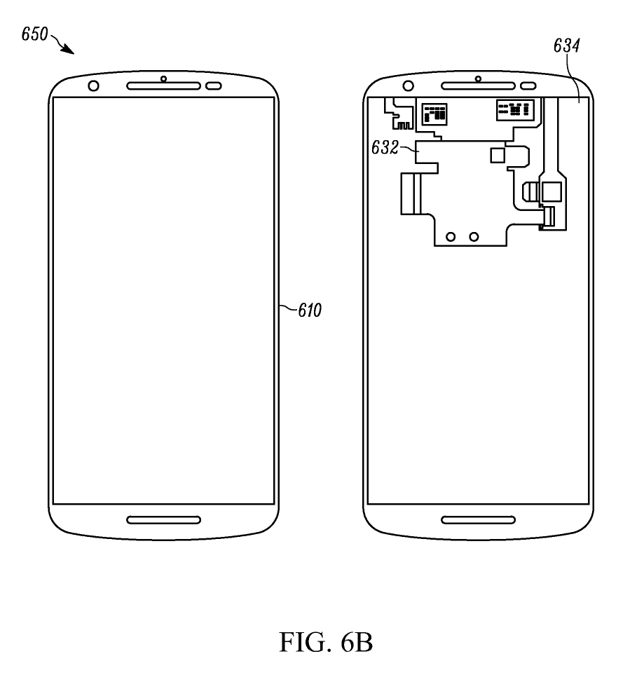

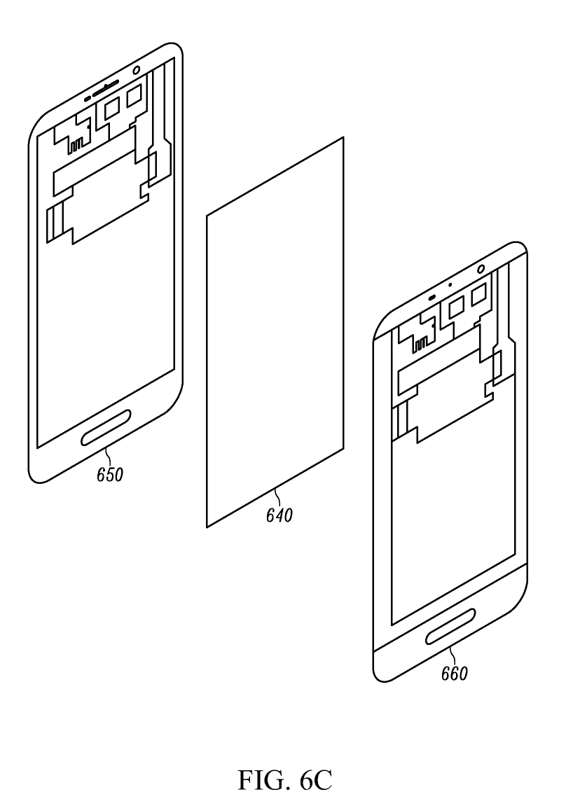

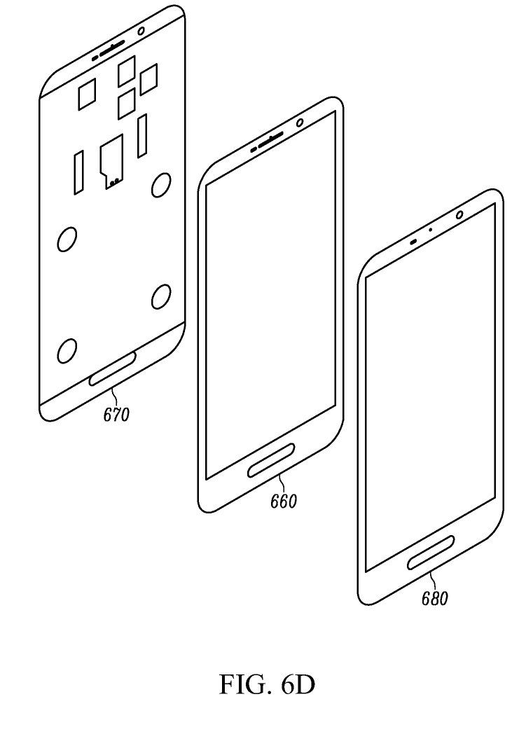

FIG. 6A is a perspective exploded view of an example mobile device in a first assembly position in accordance with an embodiment. In FIG. 6A, an example mobile device 600 includes a main lens 610, OCA 620 and LCD module 630, which when placed together form partial device 650. Main lens 610 bonds to the LCD module 630 via OCA 620.

FIG. 6B is a top view showing a general front side and backside of an LCD module for the example mobile device of FIG. 6A. Partial device 650 is shown with a front side showing main lens 610 and backside showing LCD module 630. On LCD module 630 is a display flex 632 and touch flex 634. In some embodiments, the display flex 632 connects to the touch flex 634, which controls the capacitive touch on module 634. The display flex 632 connects to the mobile device's 600 main printed circuit board (PCB) (not shown).

FIG. 6C is a perspective exploded view of an example mobile device in a second assembly position in accordance with an embodiment. A compression pad 640 is shown as assembled to the back of partial device 650 (which is LCD module 630 from FIG. 6B), resulting in main lens assembly 660. In some embodiments, fixtures can be used during assembly to ensure proper alignment.

FIG. 6D is a perspective exploded view of an example mobile device in a third assembly position in accordance with an embodiment. As provided, main lens assembly 660 is secured to front housing 670 to form a top half 680 of a mobile device.

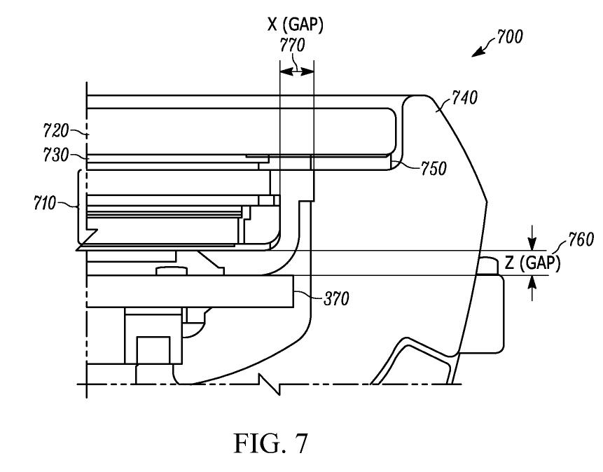

FIG. 7 is a perspective view of an example mobile device without a compression pad or display bezel. A mobile device 700 is shown having a LCD module 710, main lens 720, OCA 730, front housing 740 and mains lens adhesive 750. Also shown are an X-gap 770 and a Z-gap 760. A Y-gap is also present and identical to the X-gap, but is not shown. In some embodiments, using a compression pad reduces the X-gap 770 and Z-gap 760 and Y-gap (not shown). For example, the X-gap 770 may be reduced by approximately 0.27 mm for each side of the mobile device, the Y-gap (not shown) may be reduced by approximately 0.27 mm for each side of the mobile device, and the Z-gap 760 may be reduced by approximately 0.25 mm.

The reduction in mobile device thickness is provided in Tables 3-5. In Table 3, the mobile device thickness for a device with a display bezel is shown. Gap 2 in Table 3 provides a minimum distance used to prevent bloom or pressure marks in the mobile device using a bezel. Table 4 provides the mobile device thickness for a device without a bezel or compression pad. The Gap in Table 4 provides a minimum distance used to prevent bloom or pressure marks in the mobile device without a bezel or compression pad. Table 5 provides the mobile device thickness for a device with a compression pad.

TABLE 3
Mobile Device Thickness for Device with Display Bezel
Stack Through Display

| Description of Layer | Size (mm) |
|---|---|
| Main Lens | 0.600 |
| OCA | 0.150 |
| Display | 1.400 |
| Gap 1 | 0.050 |
| Display Bezel | 0.150 |
| Gap 2 | 0.250 |
| Chassis | 0.500 |
| Total Thickness | 3.100 |

TABLE 4
Mobile Device Thickness for Device without Bezel
Stack Through Display

| Description of Layer | Size (mm) |
|---|---|
| Main Lens | 0.600 |
| OCA | 0.150 |
| Display | 1.400 |
| Gap | 0.350 |
| Chassis | 0.500 |
| Total Thickness | 3.000 |

TABLE 5
Mobile Device Thickness for Device with Compression Pad
Stack Through Display

| Description of Layer | Size (mm) |
|---|---|
| Main Lens | 0.600 |
| OCA | 0.150 |
| Display | 1.400 |
| Gap | 0.200 |
| Chassis | 0.500 |
| Total Thickness | 2.850 |

In some embodiments, adding a pad behind a display distributes point or edge loads over an area, which results in less pressure translating through the liquid crystal layer. As the equation (Pressure=Force/Area) shows, at constant force pressure decreased if the area of applied force is increased. The reduction in pressure reduces the deflection between films and the liquid crystal layer between the two glass prisms. By reducing the deflections, light paths are less interrupted resulting in less cosmetic defects such as bloom.

Benefits associated with using a compression pad in a mobile device assembly may include:
The compression pad distributes point and line load and conforms to a gap between an LCD module display reflector and device housing.
The compression pad reduces the x-y-z device package, allowing thinner devices with a greater screen to size ratio.
   For example, using a compression pad may reduce the device by approximately 0.5 mm in both x and y directions, and may reduce the device by approximately 0.2 mm in the z direction.
   The compression pad allows the use of an LCD panel without a protective bezel while maintaining visual performance. This translates into opportunities in cost and weight savings for the device.
   For example, the device weight may be reduced by approximately 5 g by using a compression pad.
   The aspect ratio of the display active area to the size of the screen may be improved because the compression pad sits behind the display, whereas the metal bezel wraps around the display.

Accordingly, the present disclosure is not limited to only those implementations described above. Those of skill in the art will appreciate that the various illustrative modules and method steps described in connection with the above described figures and the implementations disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the disclosure. In addition, the grouping of functions within a module or step is for ease of description. Specific functions can be moved from one module or step to another without departing from the disclosure.

The various illustrative modules and method steps described in connection with the implementations disclosed herein can be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the implementations disclosed herein can be embodied directly in hardware, in a software module executed by a processor, or in a combination of the two. A software module can reside in computer or machine-readable storage media such as RAM memory, flash memory, ROM memory, EPROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

We claim:

1. A device comprising:
a liquid crystal display panel;
a bottom chassis that supports the liquid crystal display panel; and
a compression pad having a first surface facing the liquid crystal display panel and a second surface opposite the first surface, the second surface facing away from the liquid crystal display panel, the compression pad substantially filling a volume between the liquid crystal display panel and the bottom chassis.

2. The device of claim 1, wherein the liquid crystal display panel comprises a display module reflector, the display module reflector proximate to the compression pad.

3. The device of claim 1, wherein the compression pad is configured to distribute point loads in the device.

4. The device of claim 1, wherein the compression pad comprises adhesive strips configured to adhere the compression pad to the liquid crystal display panel.

5. The device of claim 1, wherein the compression pad comprises polypropylene, polyethylene terephthalate, silicone, thermoplastic urethane, or combinations thereof.

6. The device of claim 1, wherein the compression pad has a density of approximately 0.02 to 2.3 g/cm³.

7. The device of claim 1, wherein the compression pad has a 50% compression load of approximately 0.5 to 5 N/cm².

8. The device of claim 1, wherein the thickness of the compression pad is approximately 0.1 mm to 0.6 mm, and wherein the compression pad substantially fills the volume between the liquid crystal display panel and the bottom chassis.

9. The device of claim 1, further comprising:
a compression pad liner adhered to the second surface of the compression pad, the compression pad liner configured to align the compression pad with the liquid crystal display.

10. The device of claim 9, wherein the compression pad liner comprises two corners that align with two corners of the liquid crystal display panel.

11. The device of claim 9, wherein the compression pad liner is configured to be removed from the compression pad during device assembly.

12. The device of claim 1, wherein a thickness of the device is reduced by approximately 0.1 to 0.4 mm by using the compression pad.

13. The device of claim 1, wherein a length and width of the device is reduced by approximately 0.5 mm in each direction.

14. The device of claim 1, wherein the liquid crystal display panel comprises an upper prism, lower prism, back polarizer, rim adhesive, light guide frame, two brightness enhancement prisms, a light guide and reflector film.

15. The device of claim 1, wherein the bottom chassis comprises a metal floor, a printed circuit board or solid composite housing.

16. The device of claim 1, wherein a length and width of the compression pad is less than a length and width of the liquid crystal display panel.

17. A method of assembling a device comprising:
providing a liquid crystal display panel having a display module reflector;
aligning a compression pad assembly with the liquid crystal display panel, the compression pad assembly including a compression pad and a compression pad liner; and
removing the compression pad liner from the compression pad.

18. The method of claim 17, further comprising:
adhering the compression pad to the display reflector module with adhesive strips.

19. The method of claim 17, further comprising:
placing a bottom chassis proximate to the compression pad, the bottom chassis configured to support the liquid crystal display panel.

20. The method of claim 19, wherein the compression pad is compressed approximately 5% to 80% when engaged between the liquid crystal display panel and bottom chassis.

21. The method of claim 20, wherein the compression pad is compressed approximately 50% when engaged between the liquid crystal display panel and bottom chassis.

22. The method of claim 17, wherein the device comprises a device selected from the group consisting of: mobile phones, tablets, watches, laptops, and televisions.
